(19) United States
(12) Patent Application Publication
(10) Pub. No.: US 2010/0293505 A1
(43) Pub. Date: Nov. 18, 2010

(54) ANATOMY-RELATED IMAGE-CONTEXT-DEPENDENT APPLICATIONS FOR EFFICIENT DIAGNOSIS

(75) Inventors: Gundolf Kiefer, Augsburg (DE); Helko Lehmann, Aachen (DE); Dieter Geller, Aachen (DE); Hauke Schramm, Seedorf (DE); Jochen Peters, Aachen (DE); Olivier Ecabert, Aachen (DE); Juergen Weese, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,999

(22) PCT Filed: Aug. 7, 2007
(86) PCT No.: PCT/IB07/53101

§ 371 Date: Apr. 26, 2010

(30) Foreign Application Priority Data
Aug. 11, 2006 (EP) 06118818.1

(51) Int. Cl. G06F 3/048

(52) U.S. Cl. 715/810; 715/700

(57) ABSTRACT

The invention relates to a system (100) for obtaining information relating to segmented volumetric medical image data, the system comprising: a display unit (110) for displaying a view of the segmented volumetric medical image data on a display; an indication unit (115) for indicating a location on the displayed view; a trigger unit (120) for triggering an event; an identification unit (125) for identifying a segmented anatomical structure comprised in the segmented volumetric medical image data based on the indicated location on the displayed view in response to the triggered event; and an execution unit (130) for executing an action associated with the identified segmented anatomical structure, thereby obtaining information relating to the segmented volumetric medical image data. The action executed by the execution unit (130) may be displaying a name of the segmented anatomical structure, a short description of the segmented anatomical structure, or a hint on a potential malformation or malfunction of the segmented anatomical structure. Thus, the system (100) allows obtaining valuable information relating to the volumetric medical image data viewed by a physician on the display, thereby assisting the physician in medical diagnosing.

### FIELD OF THE INVENTION

The invention relates to the field of assisting physicians in medical diagnosing and more specifically to obtaining information associated with an anatomical structure comprised in medical image data.

### BACKGROUND OF THE INVENTION

A method of obtaining information associated with an anatomical structure comprised in medical image data is described in US 2005/0039127 entitled “Electronic Navigation of Information Associated with Parts of a Living Body”, hereinafter referred to as Ref 1. In this document, a system for displaying an image of a human body on a display is described. The user may select a body part of interest in a standard manner, e.g. using a mouse. In response to the user selecting the body part, information associated with physical aspects of the selected body part including symptoms and medical conditions is provided. The image of the human body may be a stylized image or a photographic image. However, obtaining information described in Ref. 1 does not involve navigating the actual human volume data.

### SUMMARY OF THE INVENTION

It would be advantageous to have a system capable of navigating volumetric medical image data for obtaining information associated with an anatomical structure comprised in the volumetric medical image data.

To better address this concern, in an aspect of the invention, a system for obtaining information relating to segmented volumetric medical image data comprises:

a display unit for displaying a view of the segmented volumetric medical image data on a display;

an indication unit for indicating a location on the displayed view;

a trigger unit for triggering an event;

an identification unit for identifying a segmented anatomical structure comprised in the segmented volumetric medical image data based on the indicated location on the displayed view in response to the triggered event; and

an execution unit for executing an action associated with the identified segmented anatomical structure, thereby obtaining information relating to the segmented volumetric medical image data.

The view of the segmented volumetric medical image data is displayed on the display. The view allows a user of the system to view and indicate the segmented anatomical structure of interest to the user. Indicating may involve standard operations such as translating, rotating, zooming-in, and/or zooming-out the segmented volumetric medical image data. The anatomical structure of interest may be the heart of a human patient. The indication unit and the trigger unit may be implemented together using a mouse device. The mouse controls the location of a pointer displayed on the display. The pointer may be used for indicating a location on the displayed view. The event may be a pointer-over event. The pointer-over event is triggered when the pointer is displayed at a location on the display for a predetermined duration. The identification unit is arranged to identify the segmented anatomical structure, e.g. the heart, shown in the view of the segmented volumetric medical image data, based on the location of the pointer controlled by the mouse in response to the triggered event. The execution unit is then arranged to execute the action associated with the identified segmented anatomical structure, e.g. with the heart, in response to the triggered event. The action may be displaying a menu comprising entries specific to the segmented anatomical structure. For example, the entries for the heart may comprise a name label “HEART”, a link to a document comprising description of common heart diseases, and a system call for executing an action for computing and for displaying the size of the left ventricle of the heart. The system thus allows obtaining information relating to the volumetric medical image data.

In an embodiment of the system, the system comprises a segmentation unit for segmenting volumetric medical image data thereby creating the segmented volumetric medical image data. Advantageously, the volumetric medical image data may be automatically, semi-automatically or manually segmented using the system. Various segmentation methods may be used by the segmentation unit of the system, for example, a segmentation method of adapting a shape model to volumetric medical image data.

In an embodiment of the system, the system further comprises an association unit for associating an action with a segmented anatomical structure. The association unit advantageously allows associating an action with a segmented anatomical structure comprised in the segmented volumetric medical image data. For example, the action to be associated with a segmented anatomical structure may be displaying a document with useful information on the segmented anatomical structure or launching an application for computing and for displaying the size of the segmented anatomical structure. The actions may be determined based on an input data from a user of the system. Optionally, the association unit may be further arranged to associate an event with an action in response to which the action is executed. For example, a first event, e.g. the mouse-over event, may be associated with a first action and a second event, e.g. a mouse-over-and-click event may be associated with a second action.

In an embodiment of the system, the action associated with the identified segmented anatomical structure is based on a model adapted to the segmented anatomical structure. This embodiment greatly facilitates associating an action with the segmented anatomical structure comprised in the segmented volumetric medical image data. For example, a data chunk comprised in or linked to the model of the anatomical structure may comprise instructions for launching an action of displaying a menu that comprises links to web pages with useful information on the anatomical structure described by the model. During model-based segmentation, the model is adapted to an anatomical structure comprised in the volumetric medical image data. Thus, the action is automatically associated with the anatomical structure during segmentation. Optionally, the data chunk comprised in or linked to the model adapted to the segmented anatomical structure may further comprise a descriptor of an event, e.g. of a mouse-over-and-click event, for executing the action associated with the segmented anatomical structure.

In an embodiment of the system, the action associated with the identified segmented anatomical structure is based on a class assigned to data elements comprised in the segmented anatomical structure. This embodiment, too, greatly facilitates associating an action with the segmented anatomical structure comprised in the segmented volumetric medical image data. For example, a data chunk comprised in or linked to the class describing the anatomical structure may comprise instructions for launching an action of displaying a web page comprising useful information on the anatomical structure. During classification of data elements, i.e. during class-based segmentation, some data elements comprised in the volumetric medical image data are classified as data elements comprised in the anatomical structure. Thus, the action is automatically associated with classified data elements, which were determined to be the data elements of the segmented anatomical structure during classification of data elements of the volumetric medical image data. Optionally, the data chunk comprised in or linked to the class describing the segmented anatomical structure may further comprise a descriptor of an event, e.g. of a mouse-over-and-click event, for executing the action associated with the identified segmented anatomical structure.

In an embodiment of the system, the action associated with the identified segmented anatomical structure is based on member image data comprising the segmented anatomical structure, the member image data being comprised in the segmented volumetric medical image data. This embodiment, too, greatly facilitates associating an action with the segmented anatomical structure comprised in the segmented volumetric medical image data. For example, a data chunk comprised in or linked to the member image data comprising the anatomical structure may comprise instructions for launching an action of displaying a web page comprising useful information on the anatomical structure. Optionally, the data chunk comprised in or linked to the member image data comprising the segmented anatomical structure may further comprise a descriptor of an event, e.g. of a mouse-over-and-click event, for executing the action associated with the identified segmented anatomical structure.

In an embodiment of the system, the action for execution by the execution unit is displaying a menu comprising at least one entry. For example, the menu may comprise an entry for launching an application for computing and displaying a property of the segmented anatomical structure. Further, the menu may comprise an entry for launching a web browser and displaying a web page that describes specific diseases and/or treatments related to the segmented anatomical structure. A menu action may offer a user of the system a plurality of useful entries for describing and/or analyzing the indicated segmented anatomical structure.

In a further aspect of the invention, an image acquisition apparatus comprises a system for obtaining information relating to segmented volumetric medical image data, the system comprising:

a display unit for displaying a view of the segmented volumetric medical image data on a display;

an indication unit for indicating a location on the displayed view;

a trigger unit for triggering an event;

an identification unit for identifying a segmented anatomical structure comprised in the segmented volumetric medical image data based on the indicated location on the displayed view in response to the triggered event; and

an execution unit for executing an action associated with the identified segmented anatomical structure, thereby obtaining information relating to the segmented volumetric medical image data.

In a further aspect of the invention, a workstation comprises a system for obtaining information relating to segmented volumetric medical image data, the system comprising:

a display unit for displaying a view of the segmented volumetric medical image data on a display;

an indication unit for indicating a location on the displayed view;

a trigger unit for triggering an event;

an identification unit for identifying a segmented anatomical structure comprised in the segmented volumetric medical image data based on the indicated location on the displayed view in response to the triggered event; and

an execution unit for executing an action associated with the identified segmented anatomical structure, thereby obtaining information relating to the segmented volumetric medical image data.

In a further aspect of the invention, a method of obtaining information relating to segmented volumetric medical image data comprises:

a display step for displaying a view of the segmented volumetric medical image data on a display;

an indication step for indicating a location on the displayed view;

a trigger step for triggering an event;

an identification step for identifying a segmented anatomical structure comprised in the segmented volumetric medical image data based on the indicated location on the displayed view in response to the triggered event; and

an execution step for executing an action associated with the identified segmented anatomical structure, thereby obtaining information relating to the segmented volumetric medical image data.

In a further aspect of the invention, a computer program product to be loaded by a computer arrangement comprises instructions for obtaining information relating to segmented volumetric medical image data, the computer arrangement comprising a processing unit and a memory, the computer program product, after being loaded, providing said processing unit with the capability to carry out the following tasks of:

displaying a view of the segmented volumetric medical image data on a display;

indicating a location on the displayed view;

triggering an event;

identifying a segmented anatomical structure comprised in the segmented volumetric medical image data based on the indicated location on the displayed view in response to the triggered event; and

executing an action associated with the identified segmented anatomical structure, thereby obtaining information relating to the segmented volumetric medical image data.

Modifications and variations of the image acquisition apparatus, of the workstation, of the method, and/or of the computer program product, which correspond to modifications of the system and variations thereof being described, can be carried out by a skilled person on the basis of the present description.

The skilled person will appreciate that the method may be applied to volumetric, i.e. three-dimensional (3D), image data acquired by various acquisition modalities such as, but not limited to, Computed Tomography (CT), Magnetic Resonance Imaging (MRI), Ultrasound (US), Positron Emission Tomography (PET), Single Photon Emission Computed Tomography (SPECT), and Nuclear Medicine (NM).

### BRIEF DESCRIPTION OF THE DRAWINGS

These and other aspects of the invention will become apparent from and will be elucidated with respect to the implementations and embodiments described hereinafter and with reference to the accompanying drawings, wherein:

FIG. 1 schematically shows a block diagram of an exemplary embodiment of the system;

FIG. 2 shows an exemplary view illustrating the heart;

FIG. 3 schematically illustrates the heart with highlighted segmented anatomical structures;

FIG. 4 illustrates a first exemplary action associated with the right coronary artery;

FIG. 5 illustrates a second exemplary action associated with the right coronary artery;

FIG. 6 illustrates an application launched upon selecting the first entry in a menu;

FIG. 7 illustrates an application launched upon selecting the fifth entry in a menu;

FIG. 8 shows a flowchart of an exemplary implementation of the method;

FIG. 9 schematically shows an exemplary embodiment of the image acquisition apparatus; and

FIG. 10 schematically shows an exemplary embodiment of the workstation.

Identical reference numerals are used to denote similar parts throughout the Figures.

### DETAILED DESCRIPTION OF EMBODIMENTS

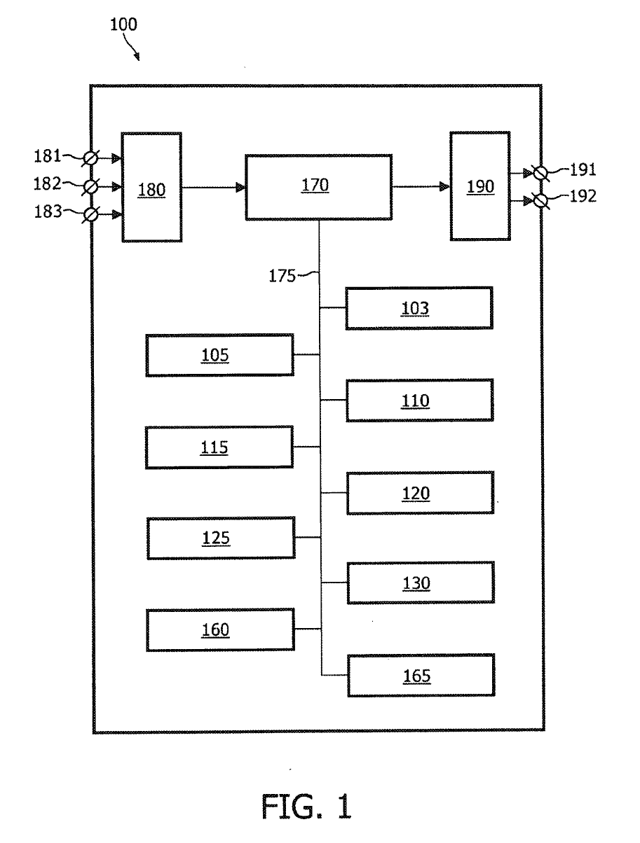

FIG. 1 schematically shows a block diagram of an exemplary embodiment of the system 100 for obtaining information relating to segmented volumetric medical image data, the system 100 comprising:

a display unit 110 for displaying a view of the segmented volumetric medical image data on a display;

an indication unit 115 for indicating a location on the displayed view;

a trigger unit 120 for triggering an event;

an identification unit 125 for identifying a segmented anatomical structure comprised in the segmented volumetric medical image data based on the indicated location on the displayed view in response to the triggered event; and

an execution unit 130 for executing an action associated with the identified segmented anatomical structure, thereby obtaining information relating to the segmented volumetric medical image data.

The exemplary embodiment of the system 100 further comprises the following units:

a segmentation unit 103 for segmenting volumetric medical image data thereby creating the segmented volumetric medical image data;

an association unit 105 for associating an action with a segmented anatomical structure;

a control unit 160 for controlling the workflow in the system 100;

a user interface 165 for communicating with a user of the system 100; and

a memory unit 170 for storing data.

In the exemplary embodiment of the system 100, there are three input connectors 181, 182 and 183 for the coming in data. The first input connector 181 is arranged to receive data coming in from data storage such as, but not limited to, a hard disk, a magnetic tape, a flash memory, or an optical disk. The second input connector 182 is arranged to receive data coming in from a user input device such as, but not limited to, a mouse or a touch screen. The third input connector 183 is arranged to receive data coming in from a user input device such as a keyboard. The input connectors 181, 182 and 183 are connected to an input control unit 180.

In the exemplary embodiment of the system 100, there are two output connectors 191 and 192 for the outgoing data. The first output connector 191 is arranged to output the data to data storage such as a hard disk, a magnetic tape, a flash memory, or an optical disk. The second output connector 192 is arranged to output the data to a display device. The output connectors 191 and 192 receive the respective data via an output control unit 190.

The skilled person will understand that there are many ways to connect input devices to the input connectors 181, 182 and 183 and output devices to the output connectors 191 and 192 of the system 100. These ways comprise, but are not limited to, a wired and a wireless connection, a digital network such as, but not limited to, a Local Area Network (LAN) and a Wide Area Network (WAN), the Internet, a digital telephone network, and an analog telephone network.

In the exemplary embodiment of the system 100, the system 100 comprises a memory unit 170. The system 100 is arranged to receive input data from external devices via any of the input connectors 181, 182, and 183 and to store the received input data in the memory unit 170. Loading the input data into the memory unit 170 allows a quick access to relevant data portions by the units of the system 100. The input data may comprise, for example, the segmented volumetric medical image data. Alternatively, the input data may comprise the volumetric medical image data for segmenting by the segmentation unit 103. The memory unit 170 may be implemented by devices such as, but not limited to, a Random Access Memory (RAM) chip, a Read Only Memory (ROM) chip, and/or a hard disk drive and a hard disk. The memory unit 170 may be further arranged to store the output data. The output data may comprise, for example, a log file documenting the use of the system 100. The memory unit 170 is also arranged to receive data from and to deliver data to the units of the system 100 comprising the segmentation unit 103, the association unit 105, the display unit 110, the indication unit 115, the trigger unit 120, the identification unit 125, the execution unit 130, the control unit 160, and the user interface 165 via a memory bus 175. The memory unit 170 is further arranged to render the output data available to external devices via any of the output connectors 191 and 192. Storing the data from the units of the system 100 in the memory unit 170 may advantageously improve the performance of the units of the system 100 as well as the rate of transfer of the output data from the units of the system 100 to external devices.

Alternatively, the system 100 may not comprise the memory unit 170 and the memory bus 175. The input data used by the system 100 may be supplied by at least one external device, such as external memory or a processor, connected to the units of the system 100. Similarly, the output data produced by the system 100 may be supplied to at least one external device, such as external memory or a processor, connected to the units of the system 100. The units of the system 100 may be arranged to receive the data from each other via internal connections or via a data bus.

In the exemplary embodiment of the system 100 shown in FIG. 1, the system 100 comprises a control unit 160 for controlling the workflow in the system 100. The control unit may be arranged to receive control data from and to provide control data to the units of the system 100. For example, after an event is triggered by the trigger unit 120, the trigger unit 120 may be arranged to pass a control data “event triggered” to the control unit 160 and the control unit 160 may be arranged to provide a control data “identify the segmented anatomical structure” to the identification unit 125 requesting the identification unit 125 to identify the segmented anatomical structure based on the indicated location. Alternatively, a control function may be implemented in another unit of the system 100.

In the exemplary embodiment of the system 100 shown in FIG. 1, the system 100 comprises a user interface 165 for communicating with the user of the system 100. The user interface 165 may be arranged to provide the user with means for rotating and translating the segmented volumetric medical image data viewed on the display. Optionally, the user interface may receive a user input for selecting a mode of operation of the system 100 such as a mode for using the segmentation unit 103 for segmenting volumetric medical image data. The skilled person will understand that more functions may be advantageously implemented in the user interface 165 of the system 100.

Volumetric, i.e. three-dimensional (3D), medical image data comprises elements. Each data element (x, y, z, I) of the volumetric medical image data comprises a location (x, y, z), typically represented by three Cartesian coordinates x, y, z in an image data coordinate system, and an intensity I at this location. The volumetric medical image data volume may be defined as a volume comprising all locations (x, y, z) comprised in the image data elements (x, y, z, I). When the medical image data comprises a plurality of member image data, each data element may further comprise a data membership index m indicating to which member image data said data element belongs. Member image data may be obtained in many different ways. For example, a first member image data may be acquired using a first image data acquisition modality and a second member image data may be acquired using a second image data modality. Alternatively, member image data may be obtained by processing medical image data, for example, by segmenting the medical image data and partitioning the medical image data into a plurality member image data based on the segmentation. The skilled person will understand that the way in which a member image data is obtained does not limit the scope of the claims.

The volumetric medical image data is segmented. Segmentation allows identifying anatomical structures in the volumetric medical image data. For example, segmented volumetric medical image data describing a heart may comprise segmented anatomical structures such as left ventricle, right ventricle, left atrium, right atrium, myocardium around the left ventricle, main trunks of the coronary arteries, ostia, and valves, for example. Segmentation may be achieved using different methods and tools comprising, but not limited to, adapting rigid, scalable, or elastically deformable models to the volumetric medical image data, using classifiers (so-called voxel classifiers) for classifying data elements of the volumetric medical image data, and classifying a data element of the volumetric medical image data based on a data membership in a multi-volume visualization. The segmented volumetric medical image data comprises the volumetric medical image data and the segmentation results.

In an embodiment of the system 100, the segmentation results comprise coordinates of vertices of adapted model meshes in the image data coordinate system. The model mesh is adapted to an anatomical structure. The model mesh describes the surface of the anatomical structure to which it is adapted. Image segmentation based on adapting model meshes to anatomical structures in volumetric medical image data is described in an article by H. Delingette entitled “General Object Reconstruction based on Simplex Meshes” in International Journal of Computer Vision, vol. 32, pages 11-142, 1999.

In an embodiment of the system 100, each data element is classified based on a feature of the data element and/or on a feature of the nearby data elements. For example, the feature of the data element may be intensity comprised in the data element and the feature of the nearby elements may be a pattern comprised in the nearby elements. Data elements assigned to one class define one segmented anatomical structure. The class of data elements defining the segmented anatomical structure is hereinafter referred to as the class of the anatomical structure. Classification may also be applied to voxels. A voxel comprises a small volume of the image volume and intensity assigned to the small volume. The skilled person will understand that a voxel may be considered an equivalent of an image data element.

Magnetic Resonance (MR) brain image data segmentation based on classification of data elements in an MR brain image data is described in an article by C.A. Cocosco et al entitled “A Fully Automatic and Robust Brain MRI Tissue Classification Method” in Medical Image Analysis, vol. 7, pages 513-527, 2003.

In an embodiment of the system 100, the medical image data comprises a plurality of member image data. Each member image data is considered to describe a segmented anatomical structure. In this embodiment, segmentation is based on image data membership.

The skilled person will appreciate that there are many methods suitable for segmenting volumetric medical image data. The scope of the claims is independent of the segmentation method.

The skilled person will also understand that the segmented volumetric medical image data may describe various segmented anatomical structures, for example, cardiac structures, lung structures, colon structures, structures of an artery tree, structures of the brain, etc.

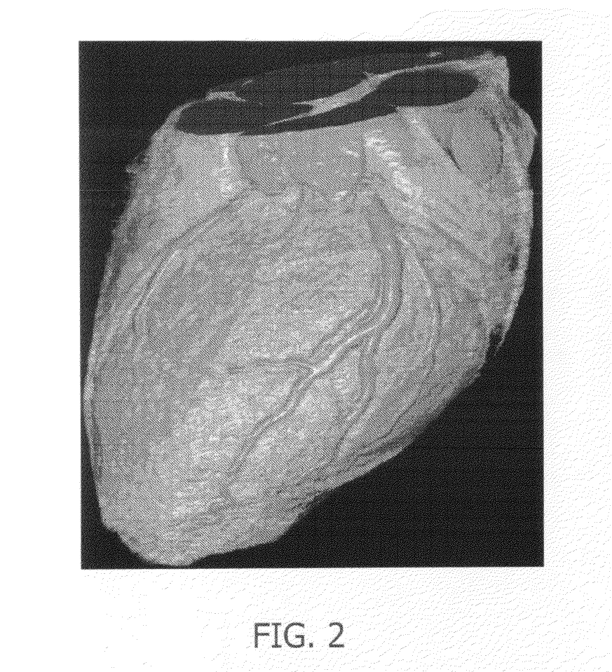

The display unit 110 of the system 100 is arranged for displaying a view of the segmented volumetric medical image data on a display. FIG. 2 shows an exemplary view illustrating the heart. The segmented anatomical structures are not highlighted in the view showed in FIG. 2. The view is computed using direct volume rendering (DVR). The skilled person will understand that there are many methods that may and can be employed for computing the view of volumetric medical image data, e.g. maximum intensity projections (MIP), iso-surface projection (ISP), digitally recomputed radiographs (DRR). In MIP, a pixel on the display is set to the maximum value along a projection ray. In ISP, projection rays are terminated when they hit the iso-surface of interest. The iso-surface is defined as the level set of the intensity function, i.e. as the set of all voxels having the same intensity. More information on MIP and ISP can be found in a book by Barthold Lichtenbelt, Randy Crane, and Shaz Naqvi, entitled “Introduction to Volume Rendering”, published by Hewlett-Packard Professional Books, Prentice Hall; Bk&CD-Rom edition (1998). In DVR, a transfer function assigns a renderable property such as opacity to intensities comprised in the segmented volumetric medical image data. An implementation of DVR is described in an article by T. He et al entitled “Generation of Transfer Functions with Stochastic Search Techniques” in Proceedings of IEEE Visualization, pages 227-234, 1996. In DRR, a projection image, e.g. an X-ray image, is reconstructed from volumetric data, e.g. from CT data. An implementation of DRR is described in an article by J. Alakijala et al entitled “Reconstructing of digital radiographs by texture mapping, ray casting and splatting” in Engineering in Medicine and Biology, 1996, Bridging Disciplines for Biomedicine, Proceedings of the 18^{th} Annual International Conference of the IEEE, vol. 2, pages 643-645, 1996.

In multi-volume visualization, the displayed image is determined based on a plurality of member image data. A few data elements belonging to different member image data may correspond to one location. A method of multi-volume DVR is described in an article by D. R. Nadeau entitled “Volume scene graphs”, published in Proceedings of the IEEE Symposium on Volume Visualization, pages 49-56, 2000.

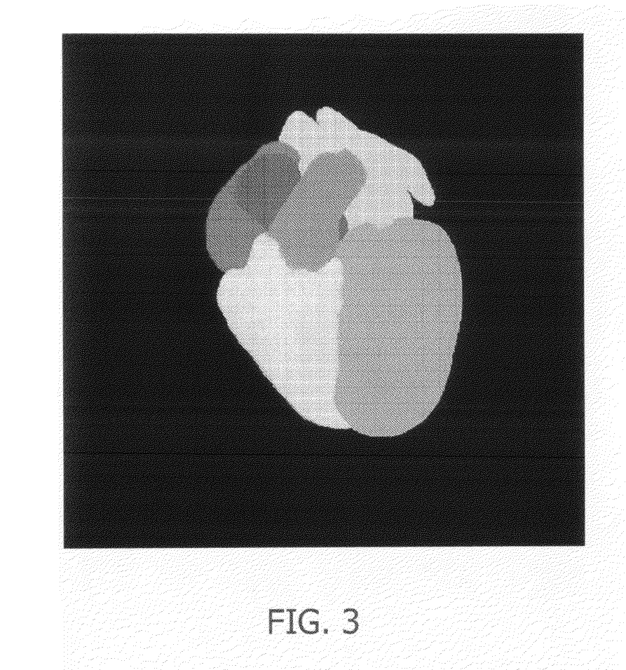

The choice of a method of computing the view of volumetric medical image data does not limit the scope of the claims. Optionally, the segmented anatomical structures may be highlighted on the displayed view. A view shown in FIG. 3 schematically illustrates the heart with marked segmented anatomical structures. Using colors to mark segmented anatomical structures allows showing more detail of the segmented anatomical structures while clearly marking the segmented anatomical structure.

In an embodiment of the system 100, the system comprises the segmentation unit 103 for segmenting volumetric medical image data thereby creating the segmented volumetric medical image data. The volumetric medical image data may be automatically, semi-automatically, and/or manually segmented using the segmentation unit 103 of the system 100. The skilled person will understand that there are many candidate segmentation systems and that a good candidate segmentation system may be integrated as a segmentation unit 103 of the system 100.

The indication unit 115 of the system 100 is arranged to indicate a location on the displayed view. The location on the displayed view is used by the identification unit 115 for identifying the segmented anatomical structure, which is of interest to the user. In an embodiment of the system 100, the indication unit 115 may be implemented using a mouse device. The user may control a pointer indicating a location on the display using the mouse device. Alternatively, the pointer may be controlled using a trackball or using a keyboard. The pointer may be replaced by another tool, e.g. by a horizontal and a vertical crosshair. The horizontal and the vertical crosshair may be controlled by a mouse or otherwise. The skilled person will understand that the method employed for indicating the location on the displayed view does not limit the scope of the claims.

The trigger unit 120 of the system 100 is arranged to trigger an event. The event triggered by the trigger unit 120 is used by the identification unit 125 to begin identifying the segmented anatomical structure. The triggered event may be further used by the execution unit 130 to determine, which action associated with the identified segmented anatomical structure is to be executed. In an embodiment of the system 100, the trigger unit 120 is implemented together with the indication unit 115 as a mouse device. The trigger unit 120 may be arranged for triggering one event, e.g. a pointer-over event or a pointer-over-and-click event. The pointer-over event may be arranged to occur when the pointer controlled by the mouse device stays at a location on the display for a predetermined period of time, e.g. for 1 second. The pointer-over-and-click event may be arranged to occur when the pointer is at a location on the display and a mouse button is clicked. Optionally, the triggering unit may be arranged for triggering a plurality of events, e.g. both the pointer-over event and the pointer-over-and-click event implemented by the mouse device. The skilled person will know other events and other ways to implement events. The exemplary embodiments of the triggering unit 120 of the system are for illustrating the invention and should not be construed as limiting the scope of the claims.

The identification unit 125 is arranged to identify a segmented anatomical structure comprised in the segmented volumetric medical image data based on the indicated location on the displayed view in response to the triggered event. The segmented anatomical structure visualized at the indicated location is the identified segmented anatomical structure. In one embodiment, the segmented anatomical structure is determined based on a probing ray starting substantially at the indicated location on the display, i.e. in the viewing plane, and propagated in a direction substantially perpendicular to the display into the visualized volume of the segmented volumetric medical image data. For example, the identification unit 125 may be arranged to probe the segmented volumetric medical image data at equidistant locations along the probing ray. At each equidistant location on the probing ray, the nearest data element is obtained from the segmented volumetric medical image data. In the case of ISP, the intensity of the nearest data element is compared to an intensity threshold of the ISP. The segmented anatomical structure, which comprises the location of the first data element with intensity greater than the intensity threshold is the identified segmented anatomical structure. Similarly, for MIP, the detected data element is the first data element with the highest intensity along the probing ray. The segmented anatomical structure, which comprises the location of the first data element with the highest intensity along the probing ray, is the identified segmented anatomical structure. Similarly, in multi-volume visualization employing DVR, an element along the probing ray is selected based on the opacity, or an alternative renderable property, assigned to the intensities of elements along the probing ray. When an element with an opacity larger than or equal to an opacity threshold is found, the data membership index of this element determines the member image data and hence, the segmented anatomical structure.

The detected data element determines the identified segmented anatomical structure. In an embodiment of the system 100, identifying the segmented anatomical structure is based on a model mesh adapted to the segmented anatomical structure comprised in the volumetric medical image data. Each adapted model mesh determines a segmented anatomical structure volume bounded by a surface of the adapted mesh. The volume of the segmented anatomical structure comprising the data element detected along the probing ray determines the identified segmented anatomical structure.

In an embodiment of the system 100, identifying the segmented anatomical structure is based on the classification of data elements of the segmented volumetric medical image data. The anatomical structure associated with the class of the data element detected along the probing ray defines the identified segmented anatomical structure.

In an embodiment of the system 100, identifying the segmented anatomical structure is based on the membership of data elements of the segmented volumetric medical image data. The membership index of the data element detected along the probing ray defines the member image data, and hence, the identified segmented anatomical structure comprised in this member image data.

If the identification unit 125 fails to identify the segmented anatomical structure based on the location indicated on the display by the indication unit 115, then the execution unit 130 may be arranged to execute a default “failed” action, e.g. displaying a message “no segmented anatomical structure is associated with the indicated location”.

The described methods of identifying a segmented anatomical structure comprised in the segmented volumetric medical image data illustrate the embodiments of the identification unit 125. The scope of the claims does not depend on the method of identifying a segmented anatomical structure comprised in the segmented volumetric medical image data employed by the identification unit 125.

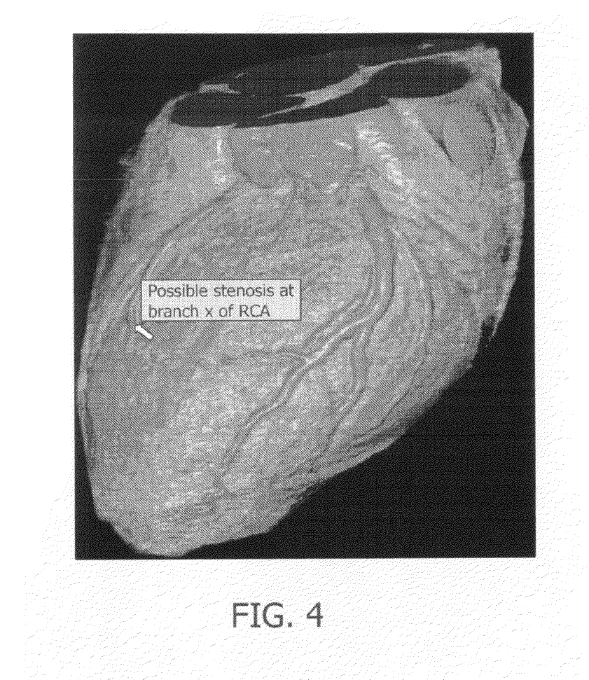

The execution unit 130 of the system 100 is arranged to execute an action associated with the identified segmented anatomical structure. FIGS. 4 to 7 illustrate possible actions. FIG. 4 illustrates a first exemplary action associated with the right coronary artery (RCA). The first exemplary action is launching a window comprising information about a possible disorder of the RCA. The sequence of occurrences leading to the execution of the first exemplary action is now described. The tip of the arrow-shaped pointer controlled by the indication unit 115 points at the indicated location. In response to the pointer-over event triggered by the trigger unit 120, the identification unit 125 identified the RCA as the segmented anatomical structure. The first exemplary action was executed by the execution unit 130 in response to the pointer-over event.

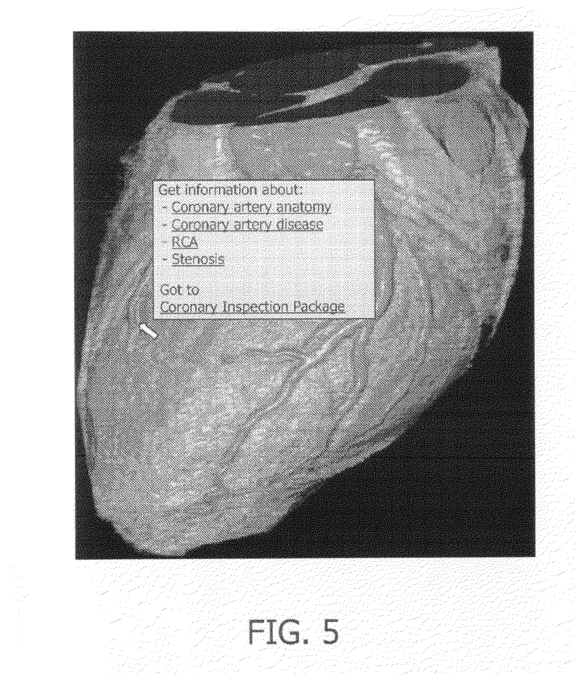

FIG. 5 illustrates a second exemplary action associated with the RCA. The second exemplary action is displaying a window comprising a menu having five entries. The first four entries provide links to local and/or external pages comprising information about the anatomy of the RCA and about the possible RCA disorder. The fifth entry is a link for launching an application called “Coronary Inspection Package”. This application may give the user further information on the viewed RCA, e.g. flow measurement data. Displaying the menu may be executed in response to another event triggered by the trigger unit 120, e.g. in response to the pointer-over-and-click event. The indicated location is the same as the location described in the preceding example. The identified segmented anatomical structure is the same RCA as in the preceding example.

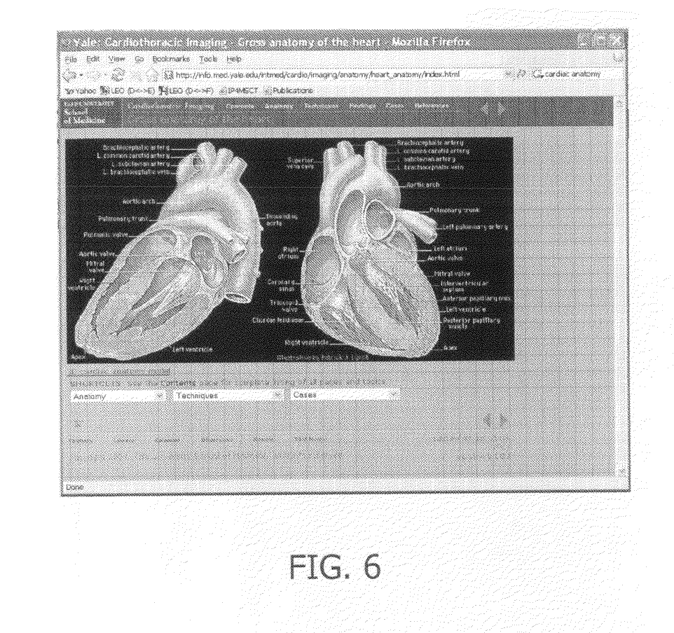

FIG. 6 illustrates an application launched upon selection of the first entry in the menu shown in FIG. 5. The application is a web browser displaying an anatomical information reference page. The page may be stored in the system 100 or may be stored in another system, e.g. on a web server. Alternatively, launching the web browser displaying the anatomical information reference page may be another exemplary action executed in response to an event triggered by the trigger unit 120, e.g. in response to mouse-over-and-double-click event.

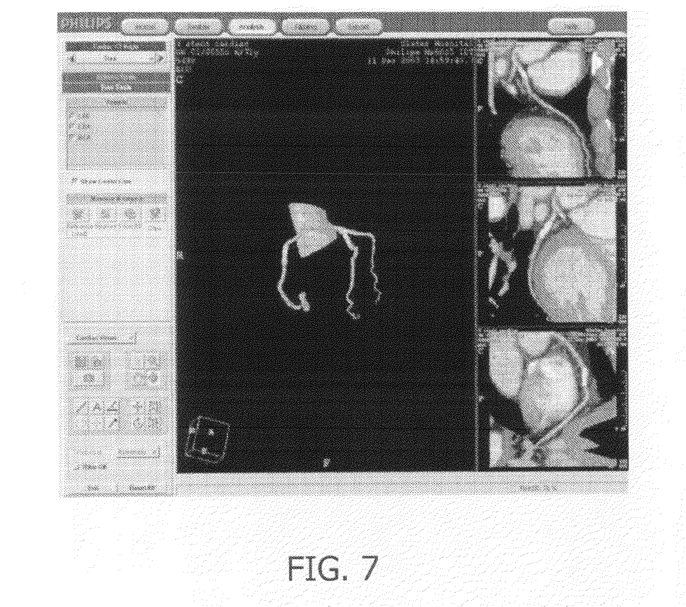

FIG. 7 illustrates an application launched upon selection of the fifth entry in the menu shown in FIG. 5. The application is a coronary artery inspection package comprising multi-planar reformatting and analysis tools. The application may be run on the system 100 or may be run on another system, e.g. on an application server. Alternatively, launching the coronary artery inspection package may be another exemplary action executed in response to an event triggered by the trigger unit 120, e.g. in response to mouse-over-and-double-click event.

There are many methods of associating an action with a segmented anatomical structure. In an embodiment of the system 100, the system 100 further comprises an association unit 105 for associating an action with a segmented anatomical structure. The association unit advantageously allows associating the action with the segmented anatomical structure comprised in the segmented volumetric image data. For example, a data chunk describing the segmented anatomical structure may comprise a table of actions associated with said segmented anatomical structures. Optionally, the table may further comprise events in response to which these actions are to be executed. The skilled person will understand that there are many ways of associating the action with the segmented anatomical structure. The scope of the claims is not limited by an implementation of associating an action with a segmented anatomical structure.

In an embodiment of the system 100, the action associated with the identified segmented anatomical structure is based on a model adapted to the segmented anatomical structure. In a further embodiment of the system 100, the action associated with the identified segmented anatomical structure is based on a class assigned to data elements comprised in the segmented anatomical structure. In a further embodiment of the system 100, the action associated with the identified segmented anatomical structure is based on member image data comprising the segmented anatomical structure, the member image data being comprised in the segmented volumetric medical image data. All these embodiments, which have already been described above, greatly facilitate associating an action with the segmented anatomical structure comprised in the segmented volumetric medical image data.

The skilled person will appreciate that it is possible to combine a few embodiments of the system 100. For example, it is possible that a member image data is further segmented and/or classified. The identification unit 125 may be arranged to identify a segmented anatomical structure comprised in the segmented and/or classified member image data. Each segmented anatomical structure comprised in the segmented and/or classified member image data may be associated with an action. The execution unit 130 may be arranged to execute the action associated with the indicated segmented anatomical structure comprised in the indicated member image data.

In an implementation of the system 100, the action for execution by the execution unit 130 is displaying a menu comprising at least one entry. There are many possible and useful entries which may be comprised in the menu. For example, the entries in the menu may be:

a name of the segmented anatomical structure;

a short description of the segmented anatomical structure;

a hint on a potential malformation or malfunction of the segmented anatomical structure; and/or

information related to the segmented anatomical structure, e.g. ejection fraction of a ventricle or an artery stenosis probability.

Further exemplary entries in the menu are:

a command for launching an application specific to the segmented anatomical structure;

a link to a database comprising information on potential diseases, malformations, and malfunctions of the segmented anatomical structure;

a link to a database dedicated to a physician, comprising data on relevant cases treated by the physician;

a link to reference information allowing the physician to access interesting case histories; and/or

a command for switching to a different visualization mode.

The skilled person will understand that a menu entry may also be implemented as the action associated with the indicated segmented anatomical structure to be executed by the system 100 in response to the triggered event.

In an embodiment of the system 100, the indication unit 115 and the trigger unit 120 control a pointer displayed on the display and the triggered event is a pointer-over event, a pointer-over-and-click event or a pointer-over-and-double-click event. These three events are easy to implement, e.g. using a mouse device, and most users are nowadays familiar with the pointer-over event, the pointer-over-and-click event, and the pointer-over-and-double-click event.

The skilled person will understand that the system 100 described in the current document may be a valuable tool for assisting a physician in medical diagnosing, in particular in interpreting and extracting information form medical image data.

The skilled person will further understand that other embodiments of the system 100 are also possible. It is possible, among other things, to redefine the units of the system and to redistribute their functions. For example, in an embodiment of the system 100, the functions of the indication unit 115 may be combined with the functions of the trigger unit 120. In a further embodiment of the system 100, there can be a plurality of segmentation units replacing the segmentation unit 103. Each segmentation unit from the plurality of segmentation units may be arranged to employ a different segmentation method. The method employed by the system 100 may be based on a user selection.

The units of the system 100 may be implemented using a processor. Normally, their functions are performed under the control of a software program product. During execution, the software program product is normally loaded into a memory, like a RAM, and executed from there. The program may be loaded from a background memory, such as a ROM, hard disk, or magnetic and/or optical storage, or may be loaded via a network like Internet. Optionally, an application-specific integrated circuit may provide the described functionality.

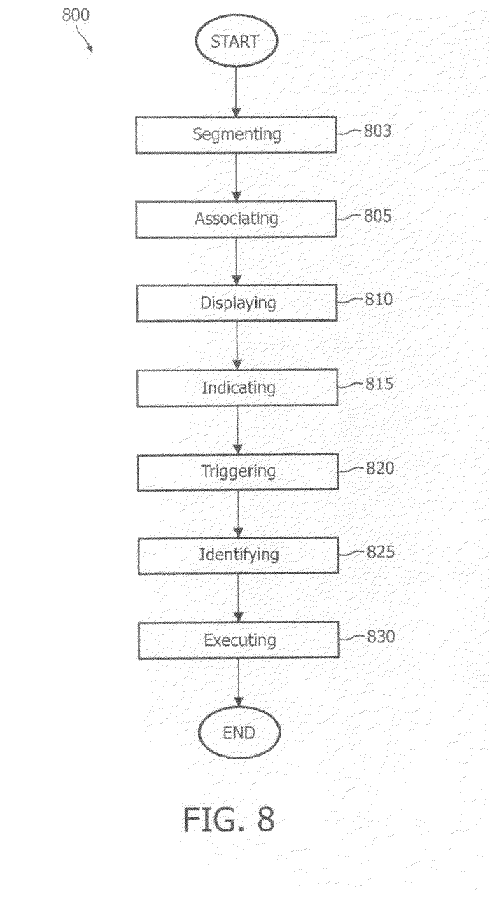

FIG. 8 shows a flowchart of an exemplary implementation of the method 800 of obtaining information relating to segmented volumetric medical image data. The method 800 begins with a segmentation step 803 for segmenting volumetric medical image data, thereby creating the segmented volumetric medical image data. After segmenting the volumetric medical image data the method 800 proceeds to an association step 805 for associating an action with a segmented anatomical structure. After the association step 805 the method 800 proceeds to a display step 810 for displaying a view of the segmented volumetric medical image data on a display. After the display step 810 the method continues with an indication step 815 for indicating a location on the displayed view. Then the method 800 continues with a trigger step 820 for triggering an event. The next step is an identification step 825 for identifying a segmented anatomical structure comprised in the segmented volumetric medical image data based on the indicated location on the displayed view in response to the triggered event. After the identification step 825 the method 800 proceeds to an execution step 830 for executing an action associated with the identified segmented anatomical structure, thereby obtaining information that relates to the segmented volumetric medical image data. After the execution step 830 the method 800 may terminate. Alternatively, the user may continue using the method 800 to obtain more information relating to segmented volumetric medical image data.

The segmentation step 803 and the association step 805 may be carried out separately from other steps, at another time and place.

The order of steps in the method 800 is not mandatory, the skilled person may change the order of some steps or perform some steps concurrently using threading models, multi-processor systems or multiple processes without departing from the concept as intended by the present invention. Optionally, two or more steps of the method 800 of the current invention may be combined to one step. Optionally, a step of the method 800 of the current invention may be split into a plurality of steps.

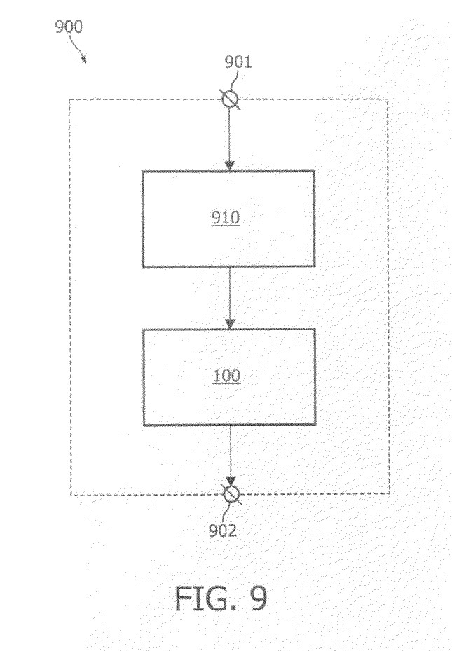

FIG. 9 schematically shows an exemplary embodiment of the image acquisition apparatus 900 employing the system 100, said image acquisition apparatus 900 comprising an image acquisition unit 910 connected via an internal connection with the system 100, an input connector 901, and an output connector 902. This arrangement advantageously increases the capabilities of the image acquisition apparatus 900 providing said image acquisition apparatus 900 with advantageous capabilities of the system 100 for obtaining information relating to segmented volumetric medical image data. Examples of image acquisition apparatus comprise, but are not limited to, a CT system, an X-ray system, an MRI system, an US system, a PET system, a SPECT system, and an NM system.

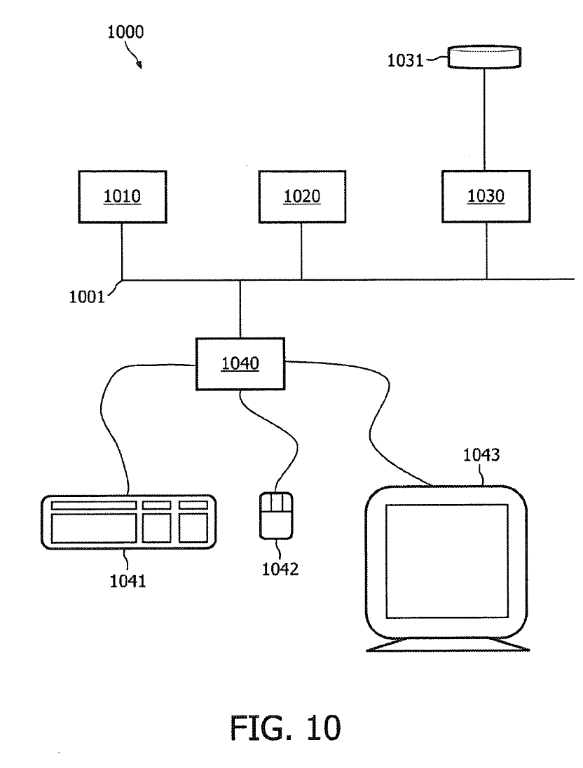

FIG. 10 schematically shows an exemplary embodiment of the workstation 1000. The workstation comprises a system bus 1001. A processor 1010, a memory 1020, a disk input/output (I/O) adapter 1030, and a user interface (UI) 1040 are operatively connected to the system bus 1001. A disk storage device 1031 is operatively coupled to the disk I/O adapter 1030. A keyboard 1041, a mouse 1042, and a display 1043 are operatively coupled to the UI 1040. The system 100 of the invention, implemented as a computer program, is stored in the disk storage device 1031. The workstation 1000 is arranged to load the program and input data into memory 1020 and execute the program on the processor 1010. The user can input information to the workstation 1000 using the keyboard 1041 and/or the mouse 1042. The workstation is arranged to output information to the display device 1043 and/or to the disk 1031. The skilled person will understand that there are numerous other embodiments of the workstation 1000 known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention can be implemented by means of hardware comprising several distinct elements and by means of a programmed computer. In the system claims enumerating several units, several of these units can be embodied by one and the same item of hardware or software. The usage of the words first, second and third, et cetera does not indicate any ordering. These words are to be interpreted as names.

1. A system (100) for obtaining information relating to segmented volumetric medical image data, the system comprising:
a display unit (110) for displaying a view of the segmented volumetric medical image data on a display;
an indication unit (115) for indicating a location on the displayed view;
a trigger unit (120) for triggering an event;
an identification unit (125) for identifying a segmented anatomical structure comprised in the segmented volumetric medical image data based on the indicated location on the displayed view in response to the triggered event; and
an execution unit (130) for executing an action associated with the identified segmented anatomical structure, thereby obtaining information relating to the segmented volumetric medical image data.

2. A system (100) as claimed in claim 1 further comprising a segmentation unit (103) for segmenting volumetric medical image data thereby creating the segmented volumetric medical image data.

3. A system (100) as claimed in claim 1 further comprising an association unit (105) for associating an action with a segmented anatomical structure.

4. A system (100) as claimed in claim 1 wherein the action associated with the identified segmented anatomical structure is based on a model adapted to the segmented anatomical structure.

5. A system (100) as claimed in claim 1 wherein the action associated with the identified segmented anatomical structure is based on a class assigned to data elements comprised in the segmented anatomical structure.

6. A system (100) as claimed in claim 1 wherein the action associated with the identified segmented anatomical structure is based on member image data comprising the segmented anatomical structure, the member image data being comprised in the segmented volumetric medical image data.

7. A system as claimed in claim 1 wherein the action for execution by the execution unit 130 is displaying a menu comprising at least one entry.

8. (canceled)

9. A system as claimed in claim 1, wherein the system is contained in an image acquisition apparatus (900) or a workstation (1000).

10. A method (800) of obtaining information relating to segmented volumetric medical image data, the method comprising:
a display step (810) for displaying a view of the segmented volumetric medical image data on a display;
an indication step (815) for indicating a location on the displayed view;
a trigger step (820) for triggering an event;
an identification step (825) for identifying a segmented anatomical structure comprised in the segmented volumetric medical image data based on the indicated location on the displayed view in response to the triggered event; and
an execution step (830) for executing an action associated with the identified segmented anatomical structure, thereby obtaining information relating to the segmented volumetric medical image data.

11. A computer program product comprising instructions for obtaining information relating to segmented volumetric medical image data, the instructions being executable by a processing unit to carry out the tasks of:
displaying a view of the segmented volumetric medical image data on a display;
indicating a location on the displayed view;
triggering an event;
identifying a segmented anatomical structure in the segmented volumetric medical image data based on the indicated location on the displayed view in response to the triggered event; and
executing an action associated with the identified segmented anatomical structure, thereby obtaining information relating to the segmented volumetric medical image data.
